(19) United States
(12) Patent Application Publication
(10) Pub. No.: US 2012/0325383 A1
(43) Pub. Date: Dec. 27, 2012

(54) ACOUSTICAL CORE FOR ABSORBING NOISE WITHIN A TIRE INTERIOR CAVITY

(75) Inventors: Joseph K. Moore, Whitby (CA); Christopher A. Stirlen, Milford, MI (US); Kenneth L. Oblizajek, Troy, MI (US); Jinshuo Zhu, Novi, MI (US); David L. Howland, Webberville, MI (US); Garland G. Wong, Markham (CA); Jeffrey D. Roman, Fenton, MI (US); Mario Turco, Ajax (CA)

(73) Assignee: GM GLOBAL TECHNOLOFGY OPERATIONS LLC, Detroit, MI (US)

(21) Appl. No.: 13/168,018

(22) Filed: Jun. 24, 2011

(51) Int. Cl. B60C 19/00; B60C 99/00; G10K 11/162; B60C 5/00

(52) U.S. Cl. 152/155; 181/175

(57) ABSTRACT

A tire assembly includes an acoustic foam core disposed within a cavity of the tire for attenuating noise. The foam core defines an expanding radial force that biases the foam core against an inner surface of the tire to secure a position of the foam core relative to the tire. The foam core may include an annular base having a plurality of nodules disposed on an outer periphery of the annular base for engaging the inner surface of the tire and to position the annular base away from the inner surface of the tire. The foam core may further include a plurality of positioning tabs disposed on opposing axial ends of the annular base for engaging side walls of the tire to position the annular base away from the side walls of the tire.

### TECHNICAL FIELD

The invention generally relates to a tire assembly, and more specifically to an acoustic foam core disposed within an interior cavity of a tire for attenuating noise from within the interior cavity.

### BACKGROUND

Pneumatic vehicular tires include an outer peripheral wall, a first side wall and a second side wall cooperating to define an interior cavity. The tire is mounted to a rim at interior perimeters, i.e., tire beads, of the first side wall and the second side wall to form a tire and wheel assembly. The rim thereby further defines and seals the cavity created by the walls of the tire, to form a volume known as the contained air volume. When the tire impacts an obstacle during use, the impact excites a cavity noise within the cavity of the tire. The energy from this cavity noise may be transmitted as a structural borne noise source into a chassis of the vehicle. The cavity noise generally includes a frequency of between one hundred eighty Hertz (180 Hz) and two hundred fifty Hertz (250 Hz), and is a function of the tire size, or more specifically is a function of the annular length of the contained air volume.

### SUMMARY

A tire assembly for a vehicle is provided. The tire assembly includes a tire having an outer peripheral wall, a first side wall and a second side wall cooperating to define an interior cavity. A core is disposed within the interior cavity of the tire. The core defines an expanding radial force that biases outward against an inner surface of the outer peripheral wall to secure a position of the core relative to the outer peripheral wall of the tire. The core includes an acoustic foam configured for attenuating noise from within the interior cavity of the tire.

A core for attenuating noise from within an interior cavity of a tire is also provided. The core includes an annular base that is concentrically disposed about a central axis. A plurality of nodules is disposed about an outer periphery of the annular base. Each of the plurality of nodules extends radially outward away from the central axis to a distal crest.

A foam core for attenuating noise from within an interior cavity of a tire is also provided. The foam core includes an annular base concentrically disposed about a central axis. A plurality of nodules is disposed about an outer periphery of the annular base. Each of the plurality of nodules extends radially outward away from the central axis to a distal crest, and defines a generally rounded shape. The foam core further includes a plurality of positioning tabs that are configured for positioning the annular base axially along the central axis of the annular base relative to a first side wall and a second side wall of the tire. The annular base includes a first axial end and a second axial, with the plurality of positioning tabs including a first group of positioning tabs and a second group of positioning tabs. The first group of positioning tabs extends axially along the central axis away from the first axial end of the annular base. The second group of positioning tabs extends axially along the central axis away from the second axial end of the annular base. The annular base, the plurality of nodules and the plurality of positioning tabs are integrally formed from an acoustic foam configured for attenuating noise between the range of one hundred thirty Hertz (130 Hz) and three hundred Hertz (300 Hz).

Accordingly, the acoustic foam core is compressible, and includes an outer diameter that is larger than the cavity diameter when the acoustic foam core is in an uncompressed state. When the acoustic foam core is compressed to fit within the cavity of the tire, the compression of the acoustic foam core generates an outwardly radial expanding force that biases against an inner surface of the outer peripheral wall of the tire, thereby securing the acoustic foam core in place relative to the tire. As such, no additional mechanical fasteners are required and/or used to secure the position of the acoustic foam core relative to the tire.

The plurality of nodules and the plurality of positioning tabs position the annular base of the acoustic foam core away from the outer peripheral wall and the first and second side walls respectively to allow air to circulate against an inner surface of the tire to maintain an even temperature distribution across the tire, and to allow tire sealant, if applied, to coat the inner surface of the tire.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic fragmentary perspective view of a tire assembly.

FIG. 2 is a schematic cross sectional view of the tire assembly along a central axis of the tire.

FIG. 3 is a schematic cross sectional view of the tire assembly perpendicular to the central axis of the tire.

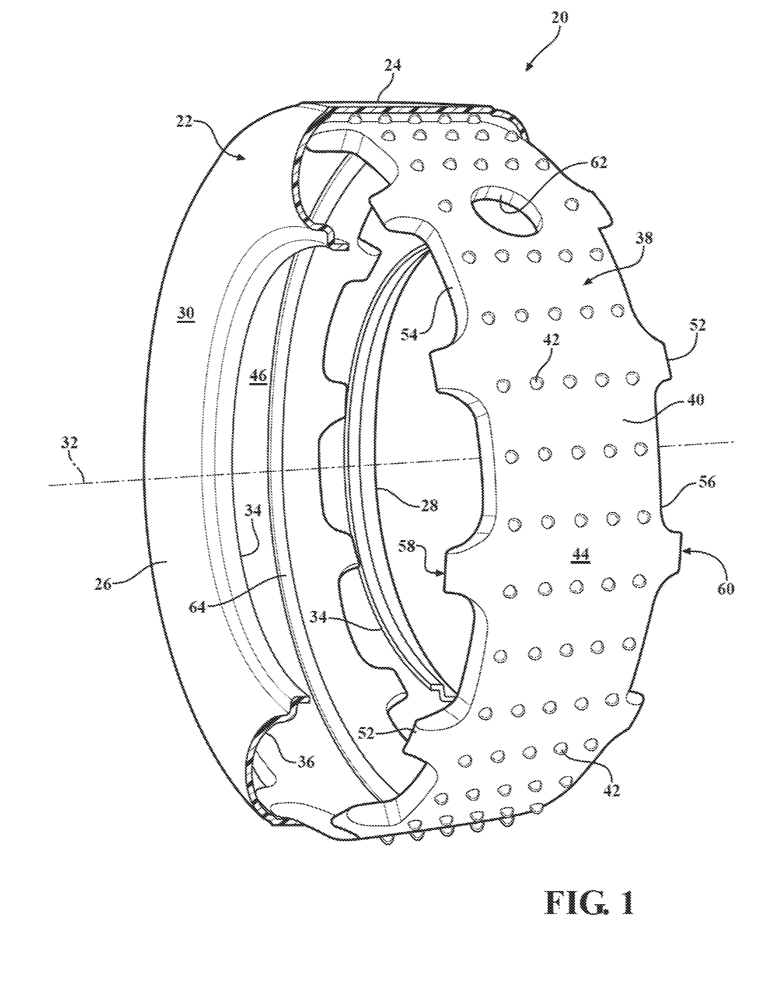

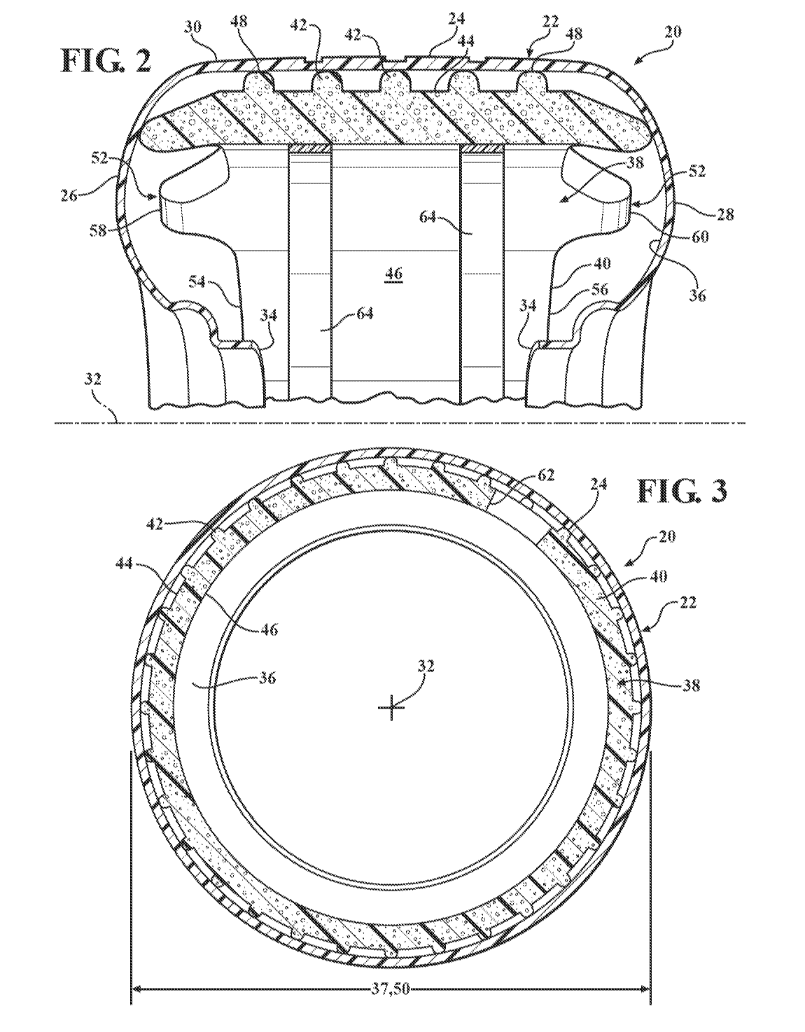

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

Referring to the Figures, wherein like numerals indicate like parts throughout the several views, a tire assembly is generally shown at 20. The tire assembly 20 includes a tire 22. The tire 22 is configured for attachment to a rim (not shown), and may include any suitable type, style size, and/or construction of tire 22, including but not limited to a radial tire or a bias ply tire.

The tire 22 includes an outer peripheral wall 24, a first side wall 26 and a second side wall 28. The outer peripheral wall 24 of the tire 22 includes an exterior 30 that defines a tread (not shown) that is configured for engaging a road surface (not shown). The first side wall 26 and the second side wall 28 extend radially inward from the outer peripheral wall 24 toward a central axis 32 of the tire 22. The first side wall 26 and the second side wall 28 each define an interior edge 34. The tire 22 is mounted to the rim at the interior edge 34 of the tire 22. The outer peripheral wall 24, the first side wall 26 and the second side wall 28 cooperate to form an interior cavity 36 of the tire 22, with the inner surfaces of the outer peripheral wall 24, the first side wall 26 and the second side wall 28 defining a cavity diameter 37. The interior cavity 36 of the tire 22 is known as the contained air volume of the tire 22. When the tire 22 is mounted to the rim, the interior cavity 36 is pressurized with gas, e.g., air, to inflate the tire 22 as is well known.

A core 38 is disposed within the interior cavity 36 of the tire 22. The core 38 includes an annular base 40 disposed concentrically about the central axis 32 of the tire 22. A plurality of nodules 42 is disposed on a radial outer surface 44 of the annular base 40. The nodules 42 support the annular base 40 in spaced relationship relative to the inner surface 46 of the outer peripheral wall 24. The plurality of nodules 42 may include any desirable number of nodules 42 sufficient to radially position the annular base 40 relative to the inner surface 46 of the outer peripheral wall 24, which is described in greater detail below. The nodules 42 may be arranged in any desirable pattern. As shown, the nodules 42 are arranged in longitudinally extending rows that are angularly spaced about the central axis 32. However, the nodules 42 may be arranged in some other arrangement not shown or described herein. Each of the nodules 42 may include a generally rounded shape. The generally rounded shape may include but is not limited to a spherical or an elliptical shape. However, it should be appreciated that the nodules 42 may include some other shape, such as but not limited to a pyramidal shape or the like. Each of the nodules 42 extends radially outward away from the central axis 32 of the annular base 40 to a distal crest 48. The distal crest 48 is the point or surface of each nodule 42 that is farthest from the central axis 32. The distal crests 48 of the nodules 42 define an outer diameter 50 of the core 38. The nodules 42 may include any suitable size, and may be much larger or much smaller than is schematically shown in the Figures. Furthermore, the nodules 42 may join to formulate a convoluted shape.

The core 38 includes a plurality of positioning tabs 52. The positioning tabs 52 are configured for positioning the annular base 40 axially along the central axis 32 of the annular base 40 relative to and between the first side wall 26 and the second side wall 28. The annular base 40 includes a first axial end 54 and a second axial end 56. The first axial end 54 is adjacent the first side wall 26, and the second axial end 56 is adjacent the second side wall 28. The plurality of positioning tabs 52 includes a first group 58 of positioning tabs 52 and a second group 60 of positioning tabs 52. The first group 58 of positioning tabs 52 extends axially along the central axis 32 away from the first axial end 54 of the annular base 40, and toward and into abutting engagement with the first side wall 26. The second group 60 of positioning tabs 52 extends axially along the central axis 32 away from the second axial end 56 of the annular base 40, and toward and into abutting engagement with the second side wall 28. The positioning tabs 52 support the annular base 40 in spaced relationship relative to the first side wall 26 and the second side wall 28. The positioning tabs 52 may include any suitable shape and/or size, and may include any desirable number suitable for maintaining the axial position of the annular base 40 between the first side wall 26 and the second side wall 28. The cross sectional shape of the positioning tabs 52 is designed to allow “flexing” of the positioning tabs 52 to accommodate various sizes of the tire 22, so that the core 38 may fit into the interior cavity 36 of several differently sized tires 22.

The annular base 40 is spaced from the outer peripheral wall 24 by the nodules 42, and is spaced from the first side wall 26 and the second side wall 28 by the first group 58 of positioning tabs 52 and the second group 60 of positioning tabs 52 respectively. The annular base 40 is spaced from the outer peripheral wall 24, the first side wall 26 and the second side wall 28 to allow air to flow between the inner surface 46 of the tire 22 and the annular base 40 of the core 38, thereby maintaining an even temperature distribution throughout the tire 22. The spacing of the annular base 40 from the outer peripheral wall 24, the first side wall 26 and the second side wall 28, allowing the airflow therebetween, also avoids buildup of excessive temperatures at critical locations on the tread of the tire 22 that may negatively affect the durability and performance of the tire 22. Additionally, maintaining the spaced relationship of the core 38 relative to the outer peripheral wall 24, the first side wall 26 and the second side wall 28 allows for any sealant injected into the interior cavity 36 to flow across and adjacent the inner surface 46 of the outer peripheral wall 24, the first side wall 26 and the second side wall 28.

In order to further facilitate air flow across the inner surfaces of the outer peripheral wall 24, the first side wall 26 and the second side wall 28, the annular base 40 may further define at least one aperture 62 extending radially through the annular base 40, perpendicular relative to the central axis 32 of the annular base 40. The annular base 40 may include any number of apertures 62 positioned in any desirable location required to achieve the desired cooling of the tire 22. Furthermore, the apertures 62 may include any suitable shape, including but not limited to a square shape, an oval shape, a polygon shape, etc., and are not limited to the circular aperture 62 shown in the Figures.

The core 38 may include and be manufactured from an acoustic foam. More specifically, the annular base 40, the plurality of nodules 42 and the plurality of positioning tabs 52 may include and be integrally formed together from the acoustic foam. The acoustic foam is configured for attenuating noise from within the interior cavity 36 of the tire 22. Preferably, the acoustic foam is configured to attenuate noise between the range of one hundred thirty Hertz (130 Hz) and three hundred Hertz (300 Hz). More specifically, the acoustic foam is configured to attenuate noise between the range of one hundred eighty Hertz (180 Hz) and two hundred fifty Hertz (250 Hz). The acoustic foam is compressible, yet includes an elasticity and a rigidity sufficient to hold a shape and position of the core 38 adjacent the inner surface 46 of the outer peripheral wall 24. Additionally, the acoustic foam includes a wear resistance sufficient to prevent wear at contact points between the core 38 and the tire 22, i.e., at the distal crests 48 of the nodules 42 and at the axial ends of the positioning tabs 52. For example, the acoustic foam may include but is not limited to an open cell foam manufactured from a polyurethane material, a polyester material or a thermoplastic material. The acoustic foam preferably includes a density between the range of twenty kilograms per cubic meter (20 kg/m³) and eighty kilograms per cubic meter (80 kg/m³), and preferably includes a cell count between the range of twenty cells per inch (20 cells/in) and eighty cells per inch (80 cells/in).

As described above, the acoustic foam core 38 includes an outer diameter 50 and is compressible. As shown and described herein, the outer diameter 50 is defined by the outer periphery of the distal crests 48 of the nodules 42. The core 38 defines an uncompressed outer diameter 50 that is greater than the cavity diameter 37 when free from the interior cavity 36, i.e., the outer diameter 50 of the core 38 is greater than the cavity diameter 37 prior to disposition of the core 38 within the cavity of the tire 22. The core 38 is compressed when disposed within the interior cavity 36 to define a compressed outer diameter 50. The compressed outer diameter 50 of the tire 22 is substantially equal to the cavity diameter 37. Compressing the core 38 to insert the core 38 into the cavity generates an expanding radial force. The expanding radial force biases the core 38 against the inner surface 46 of the outer peripheral wall 24 to secure a position of the core 38 relative to the outer peripheral wall 24 of the tire 22. Accordingly, the core 38, and particularly the nodules 42, is radially compressed when disposed within the cavity, and the resiliency of the acoustic foam generates the expanding radial force as the acoustic foam attempts to expand radially outward into the uncompressed outer diameter 50. This expanding radial force, when constrained by the outer peripheral wall 24 of the tire 22, secures the core 38 in position relative to the outer peripheral wall 24 of the tire 22. As such, no other mechanical fasteners and or bonding agents are required to secure the core 38 in position relative to the tire 22. Accordingly, the acoustic foam core 38 of predetermined dimensions may therefore be used in multiple different sizes of tires 22.

Additionally, if the acoustic foam selected for the core 38 is a softer foam, it is contemplated that the core 38 may include at least one radially expanding ring 64 to supplement and/or provide the radial expanding force if the foam core 38 is not rigid enough to remain in contact with the outer peripheral wall 24. The core 38 should include the same durability as the tire 22, i.e., the same life expectancy as the tire 22. As such, the radially expanding ring 64 may be utilized to provide structural rigidity to the foam core 38 to ensure the foam core includes the same durability as the tire 22. The radially expanding ring 64 may include a light weight yet rigid material, such as but not limited to fiberglass, or may alternatively include a hoop spring or some other similar device, disposed concentrically about the central axis 32 with the core 38 and/or the tire 22. The radially expanding ring 64 may be integrally formed into the acoustic foam core 38, or may alternatively be bonded or otherwise attached to the core 38.

While the best modes for carrying out the invention have been described in detail, those familiar with the art to which this invention relates will recognize various alternative designs and embodiments for practicing the invention within the scope of the appended claims.

1. A tire assembly for a vehicle, the tire assembly comprising:
a tire including an outer peripheral wall, a first side wall and a second side wall cooperating to define an interior cavity; and
a core disposed within the interior cavity of the tire and defining an expanding radial force biasing against an inner surface of the outer peripheral wall to secure a position of the core relative to the outer peripheral wall of the tire;
wherein the core includes an acoustic foam configured for attenuating noise from within the interior cavity of the tire.

2. A tire assembly as set forth in claim 1 wherein the inner surface of the outer peripheral wall defines a cavity diameter, wherein the core defines an uncompressed outer diameter that is greater than the cavity diameter when free from the interior cavity, and wherein the core is compressed when disposed within the interior cavity to define a compressed outer diameter substantially equal to the cavity diameter and to generate the expanding radial force.

3. A tire assembly as set forth in claim 2 wherein the core includes an annular base and a plurality of nodules, with each of the plurality of nodules extending radially outward away from a central axis of the annular base to a distal crest, wherein the outer diameter of the core is defined by an outer periphery of the distal crests of the plurality of nodules.

4. A tire assembly as set forth in claim 3 wherein the plurality of nodules each include a generally rounded shape.

5. A tire assembly as set forth in claim 3 wherein the plurality of nodules support the annular base in spaced relationship relative to the inner surface of the outer peripheral wall.

6. A tire assembly as set forth in claim 3 wherein the annular base defines at least one aperture extending radially through the annular base perpendicular relative to the central axis of the annular base.

7. A tire assembly as set forth in claim 3 wherein the core includes a plurality of positioning tabs configured for positioning the annular base axially along the central axis of the annular base relative to the first side wall and the second side wall.

8. A tire assembly as set forth in claim 7 wherein the annular base includes a first axial end adjacent the first side wall and a second axial end adjacent the second side wall, wherein the plurality of positioning tabs includes a first group of positioning tabs extending axially along the central axis from the first axial end of the annular base toward and into abutting engagement with the first side wall, and wherein the plurality of positioning tabs includes a second group of positioning tabs extending axially along the central axis from the second axial end of the annular base toward and into abutting engagement with the second side wall.

9. A tire assembly as set forth in claim 8 wherein the plurality of positioning tabs support the annular base in spaced relationship relative to the first side wall and the second side wall.

10. A tire assembly as set forth in claim 1 wherein the core includes at least one radially expanding ring to provide the radial expanding force.

11. A tire assembly as set forth in claim 1 wherein the acoustic foam is configured for attenuating noise between the range of one hundred thirty Hertz (130 Hz) and three hundred Hertz (300 Hz).

12. A core for attenuating noise from within an interior cavity of a tire, the core comprising:
an annular base concentrically disposed about a central axis; and
a plurality of nodules disposed about an outer periphery of the annular base, with each of the plurality of nodules extending radially outward away from the central axis to a distal crest.

13. A core as set forth in claim 12 wherein the plurality of nodules each include a generally rounded shape.

14. A core as set forth in claim 12 wherein the annular base defines at least one aperture extending radially through the annular base perpendicular relative to the central axis.

15. A core as set forth in claim 12 further comprising a plurality of positioning tabs configured for positioning the annular base axially along the central axis of the annular base relative to a first side wall and a second side wall of the tire.

16. A core as set forth in claim 15 wherein the annular base includes a first axial end and a second axial, wherein the plurality of positioning tabs includes a first group of positioning tabs extending axially along the central axis away from the first axial end of the annular base, and wherein the plurality of positioning tabs includes a second group of positioning tabs extending axially along the central axis away from the second axial end of the annular base.

17. A core as set forth in claim 15 wherein the annular base, the plurality of nodules and the plurality of positioning tabs are integrally formed from an acoustic foam configured for attenuating noise between the range of one hundred thirty Hertz (130 Hz) and three hundred Hertz (300 Hz).

18. A core as set forth in claim 12 further comprising at least one radially expanding ring coupled to the annular base and configured to provide a radial expanding force outward away from the central axis.

19. A foam core for attenuating noise from within an interior cavity of a tire, the foam core comprising:
an annular base concentrically disposed about a central axis;
a plurality of nodules disposed about an outer periphery of the annular base, with each of the plurality of nodules extending radially outward away from the central axis to a distal crest and defining a generally rounded shape; and
a plurality of positioning tabs configured for positioning the annular base axially along the central axis of the annular base relative to a first side wall and a second side wall of the tire;
wherein the annular base includes a first axial end and a second axial, the plurality of positioning tabs includes a first group of positioning tabs extending axially along the central axis away from the first axial end of the annular base, and a second group of positioning tabs extending axially along the central axis away from the second axial end of the annular base; and
wherein the annular base, the plurality of nodules and the plurality of positioning tabs are integrally formed from an acoustic foam configured for attenuating noise between the range of one hundred thirty Hertz (130 Hz) and three hundred Hertz (300 Hz).

20. A foam core as set forth in claim 19 further comprising at least one radially expanding ring coupled to the annular base and configured to provide a radial expanding force outward away from the central axis.
